(19) United States
(12) Patent Application Publication
(10) Pub. No.: US 2017/0161202 A1
(43) Pub. Date: Jun. 8, 2017

(54) FLASH MEMORY DEVICE INCLUDING ADDRESS MAPPING FOR DEDUPLICATION, AND RELATED METHODS

(71) Applicant: SAMSUNG ELECTRONICS CO., LTD., Suwon-si (KR)

(72) Inventors: ELONA EREZ, RAMAT GAN (IL); AVNER DOR, RAMAT GAN (IL); JUN JIN KONG, YONGIN-SI (KR)

(21) Appl. No.: 14/957,114

(22) Filed: Dec. 2, 2015

(51) Int. Cl. G06F 12/10; G06F 12/02

(52) U.S. Cl. CPC G06F 12/10; G06F 12/0246; G06F 2212/2022; G06F 2212/7201

(57) ABSTRACT

A data storage device includes a flash memory that includes blocks of physical pages that include physical sectors configured to store data therein. A memory control unit, including a flash translation layer (FTL), is configured to receive write data sectors to be stored in the flash memory, determine at least one matched data sector by matching a write data sector with a reference data sector based upon a deduplication operation, and store the reference data sector corresponding to the matched data sector in a physical sector of a physical page of a block in the flash memory. Logical-to-physical addresses of the reference data sector and the corresponding matched data sector are mapped in the FTL, and physical-to-logical information regarding the corresponding matched data sector is written in a designated physical-to-logical information area of the flash memory. The physical-to-logical information area may be a metadata area of a physical sector, an adjacent physical sector in a same page, a last sector of a block or a dedicated block of the flash memory.

### FIELD

The inventive concept is generally directed to a flash memory device and a memory controller, and more particularly, relates to a flash memory device, a memory controller, and operating methods thereof.

### BACKGROUND

Semiconductor memory devices include volatile memory devices and nonvolatile memory devices. Read and write speeds of the volatile memory device are fast, while they lose contents stored therein at power-off. In contrast, the nonvolatile memory devices retain contents stored therein even at power-off. Thus, the nonvolatile memory devices are used to store contents which must be retained regardless of whether power is supplied.

Examples of a volatile memory device include a static RAM (SRAM), a dynamic RAM (DRAM), a synchronous DRAM (SDRAM), etc. A nonvolatile memory device retains its stored data even when its power supply is interrupted. Examples of a nonvolatile memory device include a read only memory (ROM), a programmable ROM (PROM), an electrically programmable ROM (EPROM), an electrically erasable and programmable ROM (EEPROM), a flash memory, a phase change RAM (PRAM), a magnetic RAM (MRAM), a resistive RAM (RRAM), a ferroelectric RAM (FRAM), etc. A flash memory may be classified into a NOR type flash memory and a NAND type flash memory.

In particular, a flash memory device is advantageous to an appliance as an auxiliary mass storage device in that it is highly integrated as compared with a conventional EEPROM.

A variety of memory systems have been produced with use of the flash memory. The memory system stores or reads data at or from the flash memory through a protocol. A variety of techniques have been proposed to shorten a time taken to conduct the write or read operation of the memory system.

A storage device that uses a flash memory as the storage medium is considered to have increased life span, less power consumption and better access time in comparison to a storage device that includes disk drives.

A block in a NAND flash memory is a storage area of a unit for collectively erasing data, and a page is a unit for reading and writing data. A plurality of pages are typically provided in a single block. A page may include a plurality of sectors. Due to its characteristic feature, the flash memory is not typically able to directly rewrite data. In other words, when the flash memory is to rewrite data stored therein, it saves the stored valid data in another block, and then erases the stored data in block units. The flash memory thereafter writes data into the block from which the data was erased.

A host communicates with a flash memory using a flash translation layer (“FTL”). The FTL performs several functions such as address mapping, wear-leveling, garbage collection, and the like. An address mapping operation translates a logical address received from a host into a physical address, which will actually be used to store data within the flash memory. Wear-leveling may be implemented as a firmware technique for balancing the erase counts of physical blocks to fully utilize the lifetime of NAND flash, for example. A garbage collection operation may collect valid data of several blocks and fill in one block, freeing the originals.

Deduplication (or data duplication reduction) is for reducing the capacity cost of storage devices. Deduplication associates a plurality of logical blocks storing identical data with one physical block storing such data, and enables the economization of the storage data capacity. With the use of deduplication, since it is possible to reduce the data rewriting count, the life span of the flash memory can be prolonged.

In conventional approaches, the FTL inverse mapping may be written in DRAM. In identity based deduplication, if the new (or write) sector and the reference sector are identical, then deduplication can be carried out and the new sector is not written to the flash memory. The reference sector includes the logical address thereof in the metadata area. This facilitates the operation of garbage collection.

The logical address of the new (matched) sector does not appear in the metadata area, because the reference sector was already written to the flash memory and cannot be modified after programming. Therefore, the logical address of the deduplicated sector, cannot appear in the metadata area of the physical page. If the reference sector is written to the flash memory, then the mapping of the matched sector could appear in the inverse mapping (e.g. in the FTL in DRAM) for efficient garbage collection. However, the needed DRAM space may be very large (e.g. hundreds of MB). Otherwise, for each garbage collection operation the entire FTL table needs to be searched, which could add a prohibitively large latency.

### SUMMARY

The features of the embodiments of the inventive concept may reduce the RAM (e.g. DRAM) size needed for physical-to-logical FTL mapping to facilitate garbage collection when deduplication is used in a NAND flash memory.

According to an aspect of the inventive concept, a data storage device includes a control unit and a flash memory that includes blocks of physical pages that include physical sectors to store data therein. The method of operating the data storage device includes receiving write data sectors to be stored in the flash memory, determining at least one matched data sector by matching a write data sector with a reference data sector based upon a deduplication operation, and storing the reference data sector corresponding to the matched data sector in a physical sector of a physical page of a block in the flash memory. The method includes mapping logical-to-physical addresses of the reference data sector and the corresponding matched data sector in a flash translation layer (FTL) of the control unit, and writing physical-to-logical information regarding the corresponding matched data sector in a designated physical-to-logical information area of the flash memory.

In certain embodiments the physical-to-logical information comprises logical addresses of the reference data sector and the corresponding matched data sector, and the designated physical-to-logical information area comprises a metadata area in the physical sector storing the reference data sector. The deduplication operation may include the use of a buffer in the determination of the matched data sector before the reference data sector is stored in the physical sector of the physical page of the block in the flash memory.

In certain embodiments the physical-to-logical information comprises a logical address of the corresponding matched data sector, a logical address of the reference data sector is written to a metadata area in the physical sector storing the reference data sector, and the designated physical-to-logical information area comprises an adjacent physical sector, in the same physical page of the physical sector storing the reference data sector.

The at least one matched data sector may be a plurality of matched data sectors, and writing physical-to-logical information comprises writing logical addresses of the plurality of matched data sectors in the adjacent physical sector which defines an address sector of the physical page. The deduplication operation may include the use of a buffer for determining the plurality of matched data sectors before the reference data sector is stored in the physical sector of the physical page of the block in the flash memory.

In certain embodiments, the physical-to-logical information comprises an inverse-mapping-sector defined by a physical address of the physical sector storing the reference data sector, and logical addresses of the reference data sector and the corresponding matched data sector. The designated physical-to-logical information area may be a last physical sector in the block to store the inverse-mapping-sector. The designated physical-to-logical information area may be a dedicated block of the flash memory configured to store inverse-mapping-sectors for blocks of the flash memory.

The physical address in the inverse-mapping-sector may be defined by an offset relative to a first physical sector in the block. Also, a mapping of the inverse-mapping-sectors of the dedicated block may be stored in a RAM of the control unit.

The method may include performing garbage collection on the flash memory including reading the mapping of the inverse-mapping-sectors from RAM, reading the inverse mapping sectors from the flash memory, and reading the logical-to-physical addresses from the FTL. In other embodiments, performing garbage collection on the flash memory may include reading the physical-to-logical information from the designated physical-to-logical information area of the flash memory, and reading the logical-to-physical addresses from the FTL.

According to another aspect of the inventive concept, a data storage device includes a flash memory that includes blocks of physical pages that include physical sectors configured to store data therein. A memory control unit, including a flash translation layer (FTL), is configured to receive write data sectors to be stored in the flash memory, determine at least one matched data sector by matching a write data sector with a reference data sector based upon a deduplication operation, store the reference data sector corresponding to the matched data sector in a physical sector of a physical page of a block in the flash memory, map logical-to-physical addresses of the reference data sector and the corresponding matched data sector in the FTL, and write physical-to-logical information regarding the corresponding matched data sector in a designated physical-to-logical information area of the flash memory.

In certain embodiments the physical-to-logical information comprises logical addresses of the reference data sector and the corresponding matched data sector, and the designated physical-to-logical information area comprises a metadata area in the physical sector storing the reference data sector. The memory control unit may include a buffer, and the deduplication operation includes the use of the buffer for determining the matched data sector before the reference data sector is stored in the physical sector of the physical page of the block in the flash memory.

In certain embodiments the physical-to-logical information comprises a logical address of the corresponding matched data sector. The memory control unit may be configured to write a logical address of the reference data sector to a metadata area in the physical sector storing the reference data sector, and the designated physical-to-logical information area may be an adjacent physical sector, in the same physical page of the physical sector storing the reference data sector.

In various embodiments, the at least one matched data sector may include a plurality of matched data sectors, and the memory control unit is configured to write physical-to-logical information as logical addresses of the plurality of matched data sectors in the adjacent physical sector which defines an address sector of the physical page. The memory control unit may include a buffer, and the deduplication operation includes the use of the buffer for determining the plurality of matched data sectors before the reference data sector is stored in the physical sector of the physical page of the block in the flash memory.

Performing garbage collection on the flash memory may include reading the physical-to-logical information from the designated physical-to-logical information area of the flash memory, and reading the logical-to-physical addresses from the FTL.

In certain embodiments, the physical-to-logical information may comprise an inverse-mapping-sector defined by a physical address of the physical sector storing the reference data sector, and logical addresses of the reference data sector and the corresponding matched data sector. The designated physical-to-logical information area may be a last physical sector in the block to store the inverse-mapping-sector. The physical address in the inverse-mapping-sector may be defined by an offset relative to a first physical sector in the block.

Alternatively, the designated physical-to-logical information area may be a dedicated block of the flash memory configured to store inverse-mapping-sectors for blocks of the flash memory. Also, the control unit may include a RAM, and the control unit is further configured to store a mapping of the inverse-mapping-sectors of the dedicated block in the RAM.

In certain embodiments the control unit may be further configured to perform garbage collection on the flash memory including reading the mapping of the inverse-mapping-sectors from RAM, reading the inverse mapping sectors from the flash memory, and reading the logical-to-physical addresses from the FTL.

In various embodiments the physical pages may include an array of memory cells, including at least one of single-level cells (SLC), multi-level cells (MLC) and triple-level cells (TLC), coupled between word lines and bit lines.

### BRIEF DESCRIPTION OF THE DRAWINGS

The above and other aspects and features of the inventive concept will become readily understood from the detailed description that follows, with reference to the accompanying drawings, in which:

FIG. 1 is a block diagram illustrating a memory system according to an exemplary embodiment;

FIG. 2 is a detailed block diagram illustrating a memory device that is included in the memory system of FIG. 1, according to an exemplary embodiment;

FIG. 3 is a diagram illustrating a memory cell array that is included in the memory device of FIG. 2, according to an exemplary embodiment;

FIG. 4 is a circuit diagram illustrating a memory block that is included in the memory cell array of FIG. 3, according to an exemplary embodiment;

FIG. 5 is a cross-sectional view illustrating a memory cell that is included in the memory block of FIG. 4, according to an exemplary embodiment;

FIG. 6 is a circuit diagram illustrating a memory block that is included in the memory cell array of FIG. 3, according to another exemplary embodiment;

FIG. 7 is a perspective view illustrating the memory block of FIG. 6, according to an exemplary embodiment;

FIG. 8 is block diagram illustrating a memory controller that is included in the memory system of FIG. 1 according to an exemplary embodiment;

FIG. 9 is a block diagram illustrating a garbage collection in a flash memory according to a conventional approach;

FIG. 10 is a block diagram illustrating a garbage collection in a flash memory that includes deduplication according to a conventional approach;

FIG. 11 is a schematic diagram illustrating a physical sector including a physical-to-logical information area in the memory system of FIG. 1 according to an exemplary embodiment;

FIG. 12A is a schematic diagram illustrating a physical page according to a conventional approach;

FIG. 12B is a schematic diagram illustrating a physical page including a physical-to-logical information area in the memory system of FIG. 1 according to an exemplary embodiment;

FIG. 13 is a schematic diagram illustrating a flash memory cell array including a physical-to-logical information area in a last sector of a block in the memory system of FIG. 1 according to an exemplary embodiment;

FIG. 14 is a data table representing an inverse-mapping-sector as the physical-to-logical information area in the memory system of FIG. 1 according to an exemplary embodiment;

FIG. 15 is a schematic diagram illustrating a flash memory cell array including a physical-to-logical information area as a dedicated block in the memory system of FIG. 1 according to an exemplary embodiment;

FIG. 16 is a block diagram illustrating a memory card system to which a memory system is applied, according to an exemplary embodiment;

FIG. 17 is a block diagram illustrating a computing system including a memory system, according to an exemplary embodiment; and

FIG. 18 is a block diagram illustrating a solid-state drive (SSD) system to which a memory system is applied, according to an exemplary embodiment.

### DETAILED DESCRIPTION OF EMBODIMENTS

Embodiments of the inventive concept are described below with reference to the accompanying drawings. These embodiments are presented as teaching examples and should not be construed to limit the scope of the inventive concept.

In the description that follows, the terms first, second, etc. may be used to describe various elements, but these elements should not be limited by these terms. Rather, these terms are used merely to distinguish one element from another. For example, a first element could be termed a second element, and, similarly, a second element could be termed a first element, without departing from the scope of this disclosure. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

The inventive concept will now be described more fully with reference to the accompanying drawings, in which exemplary embodiments are shown. The inventive concept may, however, be embodied in many different forms and should not be construed as limited to the exemplary embodiments set forth herein. Rather, these embodiments are provided so that this disclosure will be thorough and complete, and will fully convey the scope of the inventive concept to one of ordinary skill in the art. As the inventive concept allows for various changes and numerous embodiments, exemplary embodiments will be illustrated in the drawings and described in detail in the written description. However, this is not intended to limit the inventive concept to particular modes of practice, and it is to be appreciated that all changes, equivalents, and substitutes that do not depart from the spirit and technical scope of the inventive concept are encompassed in the inventive concept. In the drawings, like reference numerals denote like elements and sizes of structures may be exaggerated for clarity.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

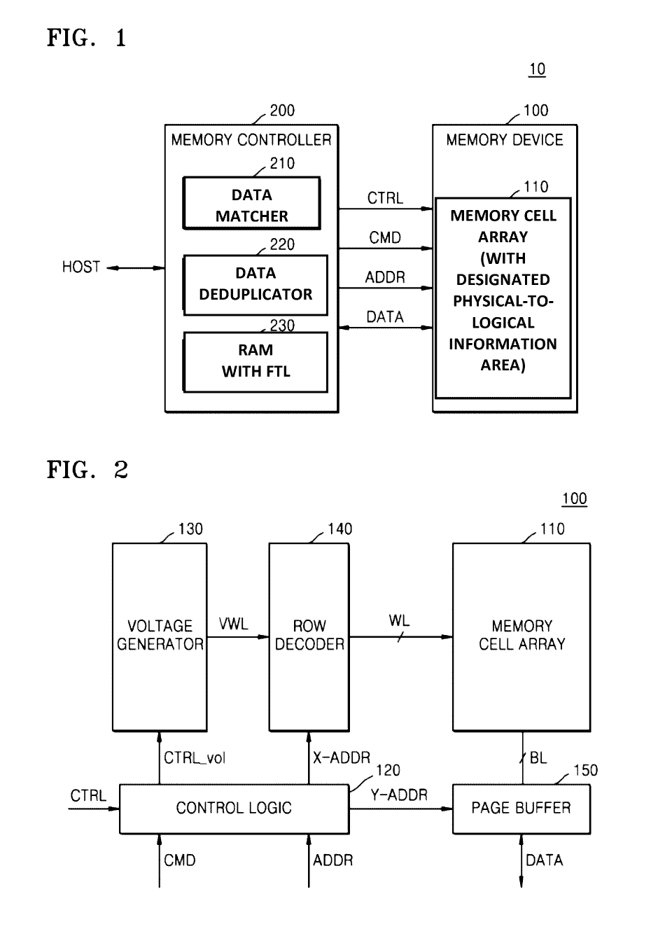

FIG. 1 is a block diagram illustrating a memory system 10 according to an exemplary embodiment. Referring to FIG. 1, the memory system 10 may include a memory device 100 (e.g. a NAND flash memory) and a memory controller 200 (e.g. also referred to as a memory control unit). The memory device 100 may include a memory cell array 110, and the memory controller 200 may include a data matcher 210, and a data deduplicator 220.

The memory cell array 110 may include a plurality of memory cells (not shown) that are provided at intersections between a plurality of word lines WL (see FIG. 2) and a plurality of bit lines BL (see FIG. 2). In an exemplary embodiment, the plurality of memory cells may be flash memory cells, and the memory cell array 110 may be a NAND flash memory cell array, for example.

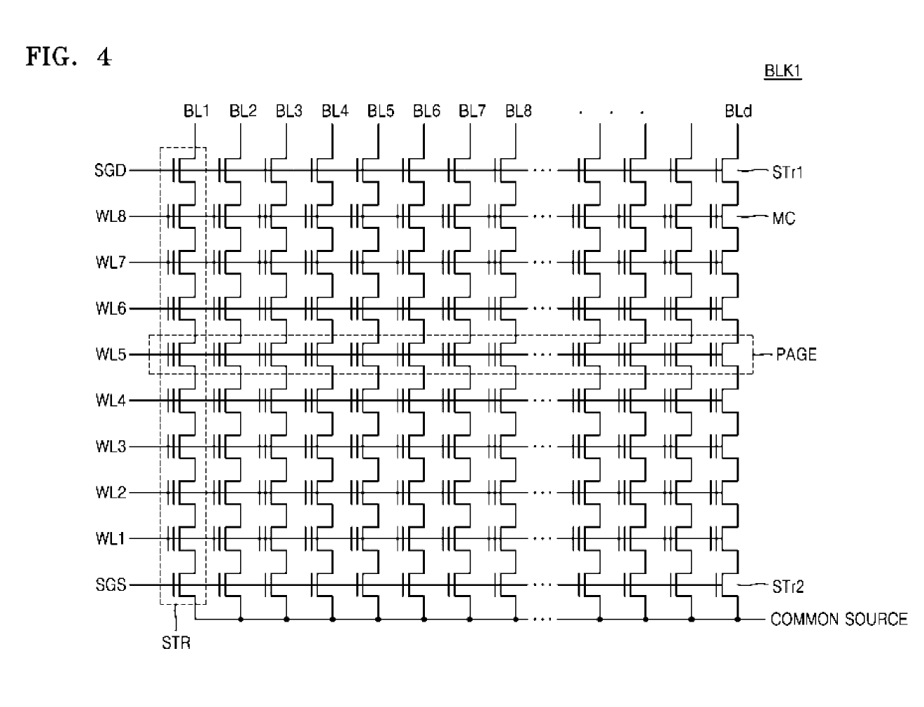

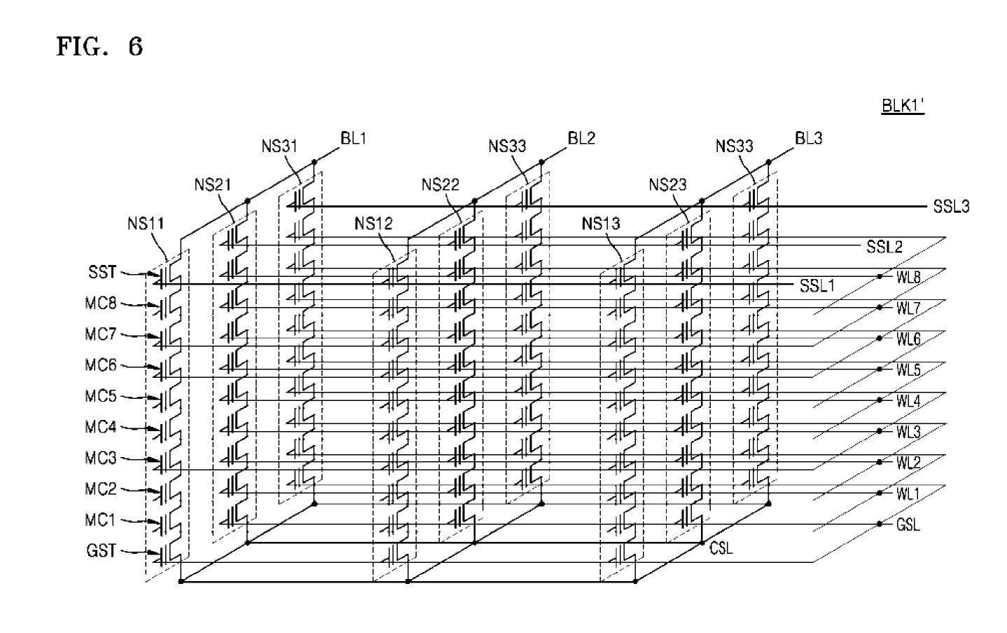

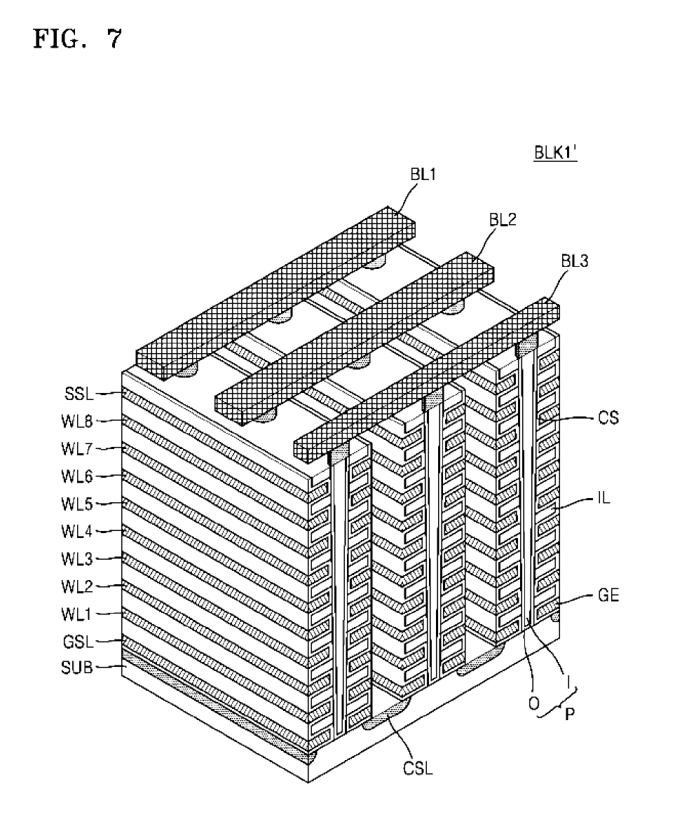

The following exemplary embodiments will be explained on the assumption that the plurality of memory cells are NAND flash memory cells. For example, the plurality of memory cells may be two-dimensional (2D) horizontal NAND flash memory cells (see FIG. 4). Alternatively, the plurality of memory cells may be three-dimensional (3D) vertical NAND flash memory cells (see FIGS. 6 and 7). However, the inventive concept is not limited thereto, and in another exemplary embodiment, the plurality of memory cells may be resistive memory cells such as resistive random-access memory (RRAM) cells, phase change RAM (PRAM) cells, or magnetic RAM (MRAM) cells.

In the present exemplary embodiment, the memory cell array 110 may be divided into a plurality of memory groups, and each of the plurality of memory groups may include a plurality of memory cells. For example, the plurality of memory groups may be divided according to memory blocks. Alternatively, the plurality of memory groups may be divided according to word lines. Alternatively, the plurality of memory groups may be divided according to pages. Alternatively, the plurality of memory groups may be divided according to dies. However, the inventive concept is not limited thereto, and the plurality of memory groups may be divided according to arbitrary program units.

In an exemplary embodiment, each of memory cells that are included in the memory cell array 110 may be a single-level cell (SLC) that stores 1-bit data. In another exemplary embodiment, each memory cell of the memory cell array 110 may be a multi-level cell (MLC) that stores 2-bit data. In another exemplary embodiment, each memory cell of the memory cell array 110 may be a triple-level cell (TLC) that stores 3-bit data. However, the inventive concept is not limited thereto, and in another exemplary embodiment, each memory cell of the memory cell array 110 may store 4 or more bits of data.

The memory controller 200 may control the memory device 100 to read data that is stored in the memory device 100 or to write data to the memory device 100 in response to a read or write request from a host HOST. Also, the memory controller 200 may control the memory device 100 to perform, for example, an operation related to a sudden power-off, a read reclaim operation, or a wear leveling operation according to an internal request instead of a request from the host HOST. Such a control operation may be referred to as a background operation.

In detail, the memory controller 200 may control a program (or a write) operation, a read operation, and an erase operation of the memory device 100 by applying an address ADDR, a command CMD, and a control signal CTRL to the memory device 100. Also, data DATA for a program operation and read data DATA may be transmitted/received between the memory controller 200 and the memory device 100.

The data matcher 210 is configured to match received write data sectors of a set with other data sectors, for example, referred to as reference data sectors that may be stored or previously received in the data stream. The data deduplicator 220 is configured to perform deduplication to jointly store the data of the matched data sectors in a respective physical page of the block of the memory device 100.

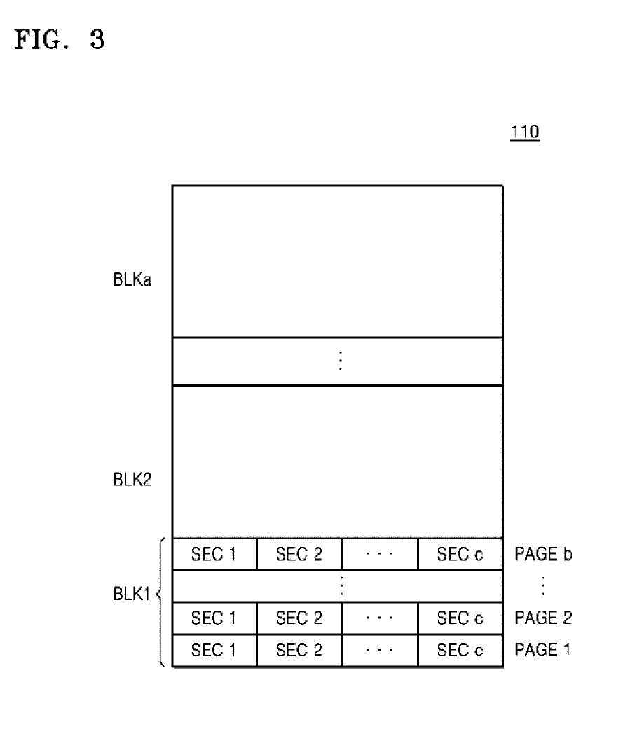

The memory controller 200, including the flash translation layer (FTL) of the RAM 230, is configured to receive write data sectors to be stored in the memory device 100, and determine (e.g. via the data matcher 210) at least one matched data sector by matching a write data sector with a reference data sector (e.g. in connection with or based upon a deduplication operation, as discussed above). The memory controller 200 is configured to store the reference data sector corresponding to the matched data sector in a physical sector (e.g. SEC 1) of a physical page (e.g. PAGE 1) of a block (e.g. BLK1) in the memory device 100 (e.g. with additional reference to FIG. 3). The memory controller 200 is configured to map logical-to-physical addresses of the reference data sector and the corresponding matched data sector in the FTL of RAM 230, and write physical-to-logical information regarding the corresponding matched data sector in a designated physical-to-logical information area in the memory cell array 110 of the memory device 100.

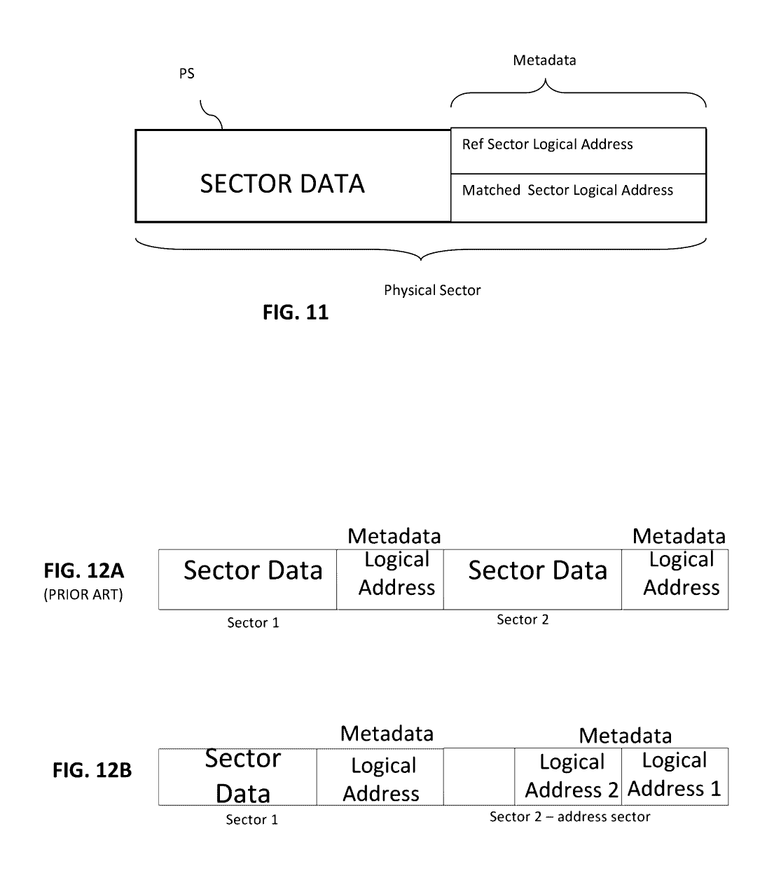

The writing of physical-to-logical information regarding the corresponding matched data sector in a designated physical-to-logical information area of the memory device 100 in accordance with features of the inventive concept will be described in further detail below with additional reference to FIGS. 11-15.

FIG. 2 is a detailed block diagram illustrating the memory device 100 that is included in the memory system 10 of FIG. 1, according to an exemplary embodiment. Referring to FIG. 2, the memory device 100 may include the memory cell array 110, a control logic 120, a voltage generator 130, a row decoder 140, and a page buffer 150. Although not shown in FIG. 2, the memory device 100 may further include an input/output circuit or an input/output interface. Elements that are included in the memory device 100 will now be explained in detail.

The memory cell array 110 may be connected to the plurality of word lines WL and the plurality of bit lines BL. Although not shown in FIG. 2, the memory cell array 110 may be connected to at least one string selection line SSL and at least one ground selection line GSL. The memory cell array 110 may include a plurality of memory cells (MC of FIG. 4 or MC1 through MC8 of FIG. 6) that are provided at intersections between the plurality of word lines WL and the plurality of bit lines BL. Each of the plurality of memory cells may store 1-bit data or multi-bit data.

When an erase voltage is applied to the memory cell array 110, the plurality of memory cells MC change to an erase state, and when a program voltage is applied to the memory cell array 110, the plurality of memory cells MC change to a program state. In this case, each of the memory cells MC may have an erase state E and at least one program state that are divided according to a threshold voltage Vth.

In an exemplary embodiment, when the memory cell MC is a single-level cell, the memory cell MC may have an erase state E and a program state P. In another exemplary embodiment, the memory cell MC may have at least one from among first through nth program states P1 through Pn, and n may be a natural number equal to or greater than 3. In an exemplary embodiment, when the memory cell MC is a multi-level cell, n is 3. In another exemplary embodiment, when the memory cell MC is a triple-level cell, n is 7.

The memory cell array 110 may include at least one selected from a single-level cell block including single-level cells, a multi-level cell block including multi-level cells, and a triple-level cell block including triple-level cells. In other words, some memory blocks from among the plurality of memory blocks that are included in the memory cell array 110 may be single-level cell blocks and other memory blocks may be multi-level cell blocks or triple-level cell blocks.

The control logic 120 may output various control signals for writing data to the memory cell array 110 or reading data from the memory cell array 110 based on the command CMD, the address ADDR, and the control signal CTRL that are received from the memory controller 200. Accordingly, the control logic 120 may generally control various operations in the memory device 100.

The various control signals that are output from the control logic 120 may be applied to the voltage generator 130, the row decoder 140, and the page buffer 150. In detail, the control logic 120 may apply a voltage control signal CTRL_vol to the voltage generator 130, a row address X_ADDR to the row decoder 140, and a column address Y_ADDR to the page buffer 150. However, the inventive concept is not limited thereto, and the control logic 120 may further apply other control signals to the voltage generator 130, the row decoder 140, and the page buffer 150.

The voltage generator 130 may generate various types of voltages for performing a program operation, a read operation, and an erase operation on the memory cell array 110 based on the voltage control signal CTRL_vol. In detail, the voltage generator 130 may generate a word line driving voltage VWL for driving the plurality of word lines WL. In this case, the word line driving voltage VWL may be a program voltage (or a write voltage), a read voltage, an erase voltage, an inhibit voltage, or a program verify voltage. Although not shown in FIG. 2, the voltage generator 130 may further generate a string selection line driving voltage VSSL for driving the plurality of string selection lines SSL and a ground selection line driving voltage VGSL for driving the plurality of ground selection lines GSL.

The row decoder 140 may be connected to the memory cell array 110 through the plurality of word lines WL, and may activate some word lines from among the plurality of word lines WL in response to the row address X_ADDR that is received from the control logic 120. In detail, during a read operation, the row decoder 140 may apply a read voltage to a selected word line and may apply an inhibit voltage to a non-selected word line. Also, during a program operation, the row decoder 140 may apply a program voltage to a selected word line and may apply an inhibit voltage to a non-selected word line.

The page buffer 150 may be connected to the memory cell array 110 through the plurality of bit lines BL. In detail, during a read operation, the page buffer 150 may output the data DATA that is stored in the memory cell array 110 by operating a sense amplifier. During a program operation, the page buffer 150 may input the data DATA to be stored to the memory cell array 110 by operating a write driver.

FIG. 3 is a diagram illustrating the memory cell array 110 that is included in the memory device 100 of FIG. 2, according to an exemplary embodiment. Referring to FIG. 3, the memory cell array 110 may be a flash memory cell array. In this case, the memory cell array 110 may include a (a is an integer equal to or greater than 2) memory blocks, that is, first through ath memory blocks BLK1 through BLKa, each of the first through ath memory blocks BLK1 through BLKa may include b (b is an integer equal to or greater than 2) pages PAGE1 through PAGEb, and each of the pages PAGE1 through PAGEb may include c (c is an integer equal to or greater than 2) sectors SEC1 through SECc. Although the pages PAGE1 through PAGEb and the sectors SEC1 through SECc of only the first memory block BLK1 are shown in FIG. 3 for convenience, the other memory blocks, that is, the second through ath memory blocks BLK2 through BLKa, may have the same structures as that of the first memory block BLK1.

FIG. 4 is a circuit diagram illustrating the first memory block BLK1 that is included in the memory cell array 110 of FIG. 3, according to an exemplary embodiment. Referring to FIG. 4, the first memory block BLK1 may be a horizontal NAND flash memory block, and each of the first through ath memory blocks BLK1 through BLKa of FIG. 3 may be formed as shown in FIG. 4. The first memory block BLK1 may include, for example, d (d is an integer equal to or greater than 2) strings STR to which 8 memory cells are serially connected. Each of the strings STR may include a drain selection transistor STr1 and a source selection transistor STr2 that are respectively connected to both ends of the memory cells MC that are serially connected. The number of the strings STR, the number of the word lines WL, and the number of the bit lines BL may be changed in various ways according to exemplary embodiments.

The flash memory device of FIG. 4 may allow an erase operation to be performed in units of memory blocks and may allow a program operation to be performed in units of pages corresponding to word lines WL1 through WL8. For example, when the memory cell MC is a single-level cell, one page may correspond to each word line. Alternatively, when the memory cell MC is a multi-level cell or a triple-level cell, a plurality of pages may correspond to each word line.

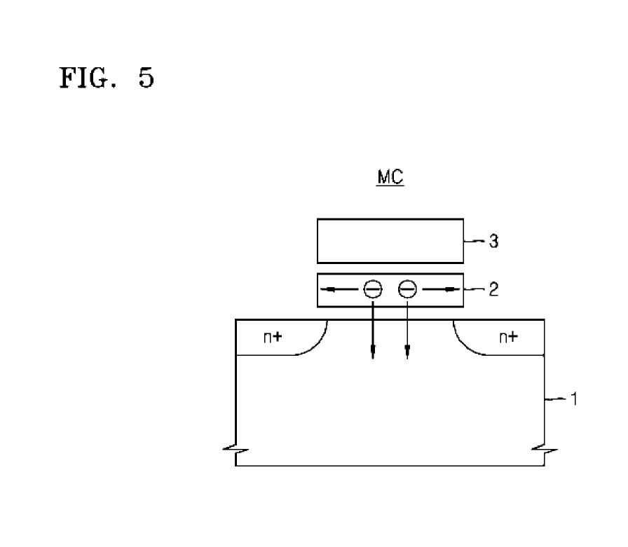

FIG. 5 is a cross-sectional view illustrating the memory cell MC that is included in the first memory block BLK1 of FIG. 4, according to an exemplary embodiment. Referring to FIG. 5, the memory cell MC may include a channel region 1, a charge storage layer 2, and a control gate 3. For example, the charge storage layer 2 may include a floating gate that is a conductor, and in this case, the memory cell MC may be referred to as a floating gate structure cell. Alternatively, the charge storage layer 2 may include, for example, silicon nitride (SiN) that is a non-conductor, and in this case, the memory cell MC may be referred to as a charge trap flash (CTF) cell.

To perform a program operation on the memory cell MC, a relatively high program voltage may be applied to the control gate 3 and a relatively low voltage (for example, 0 V) may be applied to the channel region 1. Since an electric field is formed in a direction from the control gate 3 to the channel region 1 according to such a bias condition, charges, for example, electrons, may move from the channel region 1 to the charge storage layer 2, and thus the memory cell MC may be programmed.

When the memory device 100 is a flash memory device, data that is stored in the memory cell MC may be read according to the threshold voltage Vth of the memory cell MC. In this case, the threshold voltage Vtgh of the memory cell MC may be determined by the number of electrons that are stored in the charge storage layer 2. In detail, as the number of electrons that are stored in the charge storage layer 2 increases, the threshold voltage Vth of the memory cell MC may increase.

FIG. 6 is a circuit diagram illustrating a first memory block BLK1′ that is included in the memory cell array 110 of FIG. 3, according to another exemplary embodiment. Referring to FIG. 6, the first memory block BLK1′ may be a vertical NAND flash memory block, and the first through ath memory blocks BLK1 through BLKa of FIG. 3 may be formed as shown in FIG. 6. The first memory block BLK1′ may include a plurality of NAND strings NS11 through NS33, the plurality of word lines WL1 through WL8, a plurality of bit lines BL1 through BL3, the ground selection line GSL, a plurality of string selection lines SSL1 through SSL3, and a common source line CSL. The number of the NAND strings, the number of the word lines, the number of the bit lines, the number of the ground selection lines, and the number of the string selection lines may be changed in various ways according to exemplary embodiments.

The NAND strings NS11 through NS33 are connected between the bit lines BL1 through BL3 and the common source line CSL. Each of the NAND strings NS11 through NS33 (for example, NS11) may include a string selection transistor SST, the plurality of memory cells MC1 through MC8, and a ground selection transistor GST that are serially connected.

The string selection transistor SST is connected to the string selection lines SSL1 through SSL3. The plurality of memory cells MC1 through MC8 are respectively connected to the word lines WL1 through WL8. The ground selection transistor GST is connected to the ground selection line GSL. The string selection transistor SST is connected to the bit line BL corresponding to the string selection transistor SST, and the ground selection transistor GST is connected to the common source line CSL.

Word lines having the same height (for example, the word lines WL1) are commonly connected, and the string selection liens SSL1 through SSL3 are separated from one another. When memory cells that are connected to the first word lines WL1 and belong to the NAND strings NS11, NS12, and NS13 are programmed, the first word line WL1 and the first string selection line SSL1 are selected.

FIG. 7 is a perspective view illustrating the first memory block BLK1′ of FIG. 6, according to an exemplary embodiment. Referring to FIG. 7, the first memory block BLK1′ is formed in a direction that is perpendicular to a substrate SUB. The common source line CSL is disposed in the substrate SUB, and gate electrodes GE and insulating layers IL are alternately stacked on the substrate SUB. Also, a charge storage layer CS may be formed between the gate electrodes GE and the insulating layers IL.

When the plurality of gate electrodes GE and the plurality of insulating layers IL that are alternately stacked are vertically patterned, a pillar P having a V-shape is formed. The pillar P passes through the gate electrodes GE and the insulating layers IL and is connected to the substrate SUB. An outer portion O of the pillar P may be formed of a semiconductor material and may function as a channel region, and an inner portion I of the pillar P may be formed of an insulating material such as silicon oxide.

The gate electrodes GE of the first memory block BLK1′ may be connected to the ground selection line GSL, the plurality of word lines WL1 through WL8, and the string selection line SSL. The pillar P of the first memory block BLK1′ may be connected to the plurality of bit lines BL1 through BL3. Although the first memory block BLK1′ includes two selection lines GSL and SSL, eight word lines WL1 through WL8, and three bit lines BL1 through BL3 in FIG. 7, the number of the elements is not limited thereto and various modifications may be made.

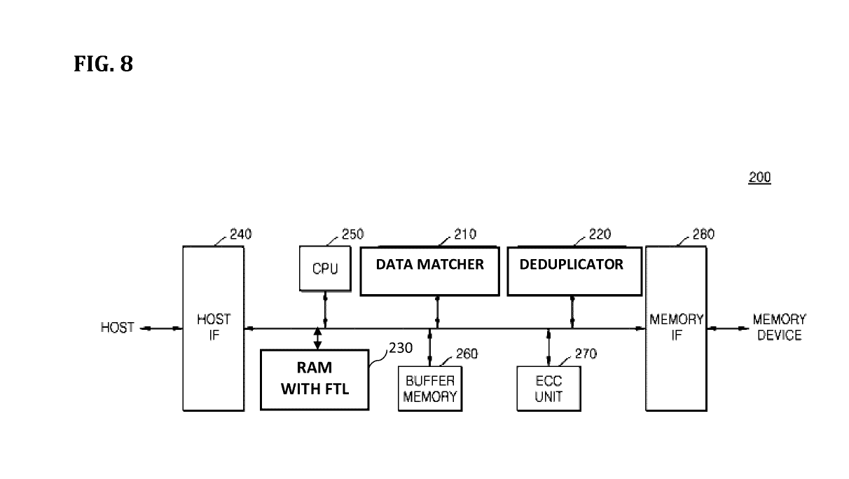

FIG. 8 is a detailed block diagram illustrating the memory controller 200 that is included in the memory system 10 of FIG. 1, according to an exemplary embodiment. Referring to FIG. 8, the memory controller 200 may include the data matcher 210, the data deduplicator 220, a RAM 230 that includes the flash translation layer (FTL), a host interface 240, a central processing unit (CPU) 250, a buffer memory 260, an error correction code (ECC) unit 270, and a memory interface 280.

The host interface 240 may receive a request of a memory operation from a host by interfacing with the host. In detail, the host interface 240 may receive various requests such as a data read request and a data write request from the host, and generates various internal signals for the memory operation of the memory device 100 in response to the various requests. For example, the memory controller 200 may be configured to communicate with the host through at least one selected from various interface protocols such as a universal serial bus (USB), multimedia card (MMC), peripheral component interconnect-express (PCI-E), advanced technology attachment (ATA), serial-ATA, parallel-ATA, small computer system interface (SCSI), enhanced small disk interface (ESDI), and integrated drive electronics (IDE).

The CPU 250 may control an overall operation of the memory controller 200. For example, the CPU 250 may control various functional blocks related to the memory operation of the memory device 100. Although the data matcher 210 and the data deduplicator 220 are shown as separate blocks in the present exemplary embodiment, such features may operate as a part of the CPU 250.

The buffer memory 260 may temporarily store data that is transmitted to the outside through the host interface 240 and data that is transmitted from the memory device 100 through the memory interface 280. Also, the buffer memory 260 may temporarily store information that is necessary to control the memory device 100. For example, although the buffer memory 260 may be a dynamic RAM (DRAM), a static RAM (SRAM), or a combination of the DRAM and the SRAM, the inventive concept is not limited thereto.

The ECC unit 270 may perform ECC encoding on write data and ECC decoding on read data by using an algorithm such as a Reed-Solomon (RS) code, a Hamming code, or a cyclic redundancy code (CRC), may generate an error detection result from data that is read from the memory device 100, and may perform error correction on the read data. For example, the ECC unit 270 may detect an error bit by comparing a parity bit that is generated and stored when data is programmed with a parity bit that is generated when data is read, and may correct the error bit by performing a predetermined logic operation (for example, exclusive OR (XOR)) on the detected error bit.

The memory interface 280 may interface with the memory device 100 to transmit and receive various signals (for example, a command, an address, and a read voltage control signal) that are generated in the memory controller 200.

A host HOST communicates with the memory device 110 using the FTL, for example, in connection with the RAM 230. The FTL performs several functions such as address mapping, wear-leveling, garbage collection, and the like. An address mapping operation translates a logical address received from a host into a physical address, which will actually be used to store data within the memory device 100. Wear-leveling may be implemented as a firmware technique for balancing the erase counts of physical blocks to fully utilize the lifetime of the memory device 100, for example, a NAND flash. A garbage collection operation may collect valid data of several blocks and fill in one block, freeing the original blocks.

The data matcher 210 matches newly received data (e.g. write data sectors) with reference data sectors (e.g. previously stored or received earlier in the data stream from the host), and the deduplicator 210 performs deduplication which associates a plurality of matched data sectors having identical data with one physical sector storing such data, and enables the economization of the storage data capacity.

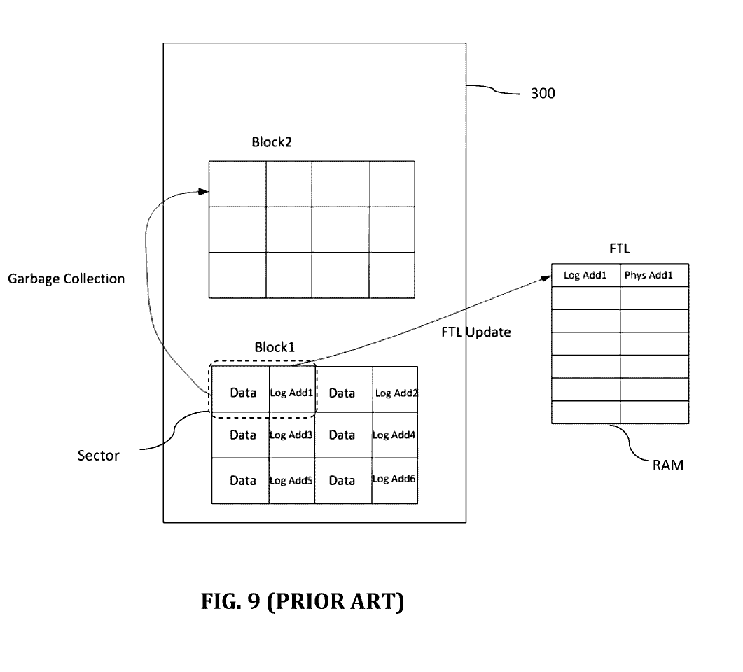

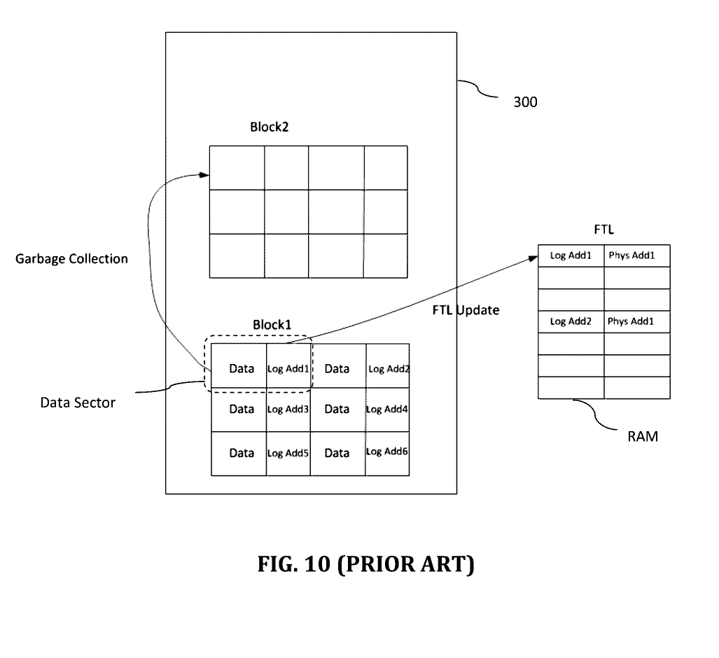

With additional reference to FIGS. 9 and 10, in conventional approaches, FTL inverse mapping may be written in a RAM (e.g. DRAM) of the memory controller. In identity based deduplication, if the new (or write) sector and the reference sector are identical, then deduplication can be carried out and the new sector is not written to the memory device 300. The physical data sector storing the reference data sector includes the logical address thereof in the metadata area. This may facilitate the operation of garbage collection.

The logical address of the new (matched) sector does not appear in the metadata area, because the reference sector was already written to the flash memory and cannot be modified after programming. If the reference sector is written to the flash memory, then the mapping of the matched sector should appear in the inverse mapping (e.g. in the FTL in DRAM) for efficient garbage collection. However, the needed DRAM space may be very large (e.g. hundreds of MB).

FIG. 9 illustrates how the logical address in the metadata area is used in garbage collection when there is no deduplication in a conventional approach. For discussion herein, it is assumed that page size is 8K and sector size (FTL unit) is 4K. That is, each page includes two sectors and each sector includes a data area and metadata area. Upon garbage collection, valid pages from the victim block (e.g. Block1) are copied to another block (e.g. Block2). The FTL needs to be updated, so that the copied logical pages are mapped into the new physical addresses of the physical pages. The logical addresses in the metadata area are used to locate the logical addresses in the FTL and the mapping is accordingly updated.

FIG. 10 illustrates the situation when there is identity based deduplication in a conventional approach. In the FTL there are 2 logical addresses that are mapped to the same physical address, due to the matching and deduplication operation. However, during garbage collection, only one of the logical addresses appears in the metadata area of the physical page and can be used to locate the address in the FTL. So, the logical address of the matched sector in the FTL needs to be located to update the physical address upon garbage collection.

As such, a conventional approach is to save the inverse mapping in the RAM (e.g. DRAM), in addition to the logical-to-physical address mapping of the FTL. With this approach, the FTL size may be doubled, e.g. as a typical value, the FTL size can be increased by 432 MB. There are other approaches where deduplication is carried out only in certain parts of the memory device 300, but the associated RAM space is still large, and the deduplication rate and performance may be significantly reduced.

Thus, features of the embodiments of the inventive concept may reduce the RAM (e.g. DRAM) size needed for physical-to-logical FTL mapping to facilitate garbage collection when deduplication is used in a memory device 100, e.g. a NAND flash memory. In accordance with features of the inventive concept, physical-to-logical information regarding the corresponding matched data sector is written in a designated physical-to-logical information area of the memory device 100, and further details will be described now with additional reference to FIGS. 11-15.

In the embodiment of FIG. 11, which shows a physical sector PS of a page of a block of the memory cell array 110 of the memory device 100, the physical-to-logical information comprises logical addresses of the reference data sector and a corresponding matched data sector. In this embodiment, the designated physical-to-logical information area is a metadata area in the physical sector PS storing the reference data sector (e.g. sector data). Here, the memory controller 200 (e.g. via the data matcher 210 and deduplicator 220) may perform the deduplication operation with the use of a buffer (e.g. RAM 230) for use in determining the matched data sector before the reference data sector is stored in the physical sector of the physical page of the block in the flash memory.

The approach of this embodiment does not require additional mapping to the FTL. In the FTL both the reference data sector logical address and the matched data sector logical address are mapped to the same physical sector PS address. Logical addresses in the physical sector PS facilitate garbage collection. However, in this embodiment, only two data sectors may be referenced to the same physical sector PS. As mentioned, the approach may need the use of a buffer (such as the DRAM buffer) since the matched data sectors need to be determined before the reference data sector is written to the memory device 100, e.g. the NAND flash memory, so that both logical addresses can be written to the metadata area. Here, the size of the metadata area may be increased in order to accommodate the second logical address.

In another embodiment, for example, as shown in FIG. 12B (in comparison to a conventional approach shown in FIG. 12A), the physical-to-logical information comprises a logical address of the corresponding matched data sector. The memory controller 200 may be configured to write a logical address of the reference data sector to a metadata area in the physical sector (e.g. Sector 1) storing the reference data sector. In this embodiment, the designated physical-to-logical information area is an adjacent physical sector (e.g. Sector 2), in the same physical page of the physical sector (Sector 1) storing the reference data sector.

So, here, the matched data sector may include a plurality of matched data sectors, and the memory controller 200 is configured to write physical-to-logical information as logical addresses (e.g. Logical Address 1 and Logical Address 2) of the plurality of matched data sectors in the adjacent physical sector (Sector 2) which defines an “address sector” of the physical page. Again, the memory controller 200 may include the use of a buffer (e.g. RAM 230) in the deduplication operation for use in determining the plurality of matched data sectors before the reference data sector is stored in the physical sector (Sector 2) of the physical page of the block in the memory cell array 110 of the memory device 100.

In this embodiment, more than two identical data sectors (e.g. of 4K) can be matched. The reference data sector (data+logical address) is written to the physical sector (Sector 1) while the logical addresses only of the other matched sectors (e.g. 2 or more) are written to the second physical sector (Sector 2) of the same physical page. Such second sector in the page may be referred to as an “address sector” since it contains only logical addresses of matched data sectors. This approach does not require additional mapping to the FTL. In the FTL both the reference data sector logical address and the matched data sector logical address are mapped to the same physical sector (Sector 1) address.

Reading and updating the FTL are similar to a conventional FTL. Logical addresses stored in the memory cell array 110 of the memory device 100 facilitate garbage collection. Upon garbage collection, the logical addresses of matched data sectors are read from the address sector (i.e. Sector 2). A large number of data sectors can be matched to the same reference data sector, since there is a lot of space in the address sector. The size of the metadata area does not need to be increased, since the logical addresses in the address sector may be written in the data area thereof.

As mentioned, the approach of this embodiment may need the use of a buffer (such as the DRAM buffer) since the matched data sectors need to be determined before the reference data sector is written to the memory device 100, e.g. the NAND flash memory, so that the logical addresses of the matched data sectors will be written to the second sector (Sector 2) of the same page.

A deduplication rate may be affected, for example, since a benefit in terms of a number of writes may be gained only if there are more than two matched data sectors. If there are only two matched data sectors, they will still occupy two physical sectors, e.g. the first (Sector 1) for the data and logical address of the reference data sector, and the second (Sector 2) for the logical address of the matched data sector.

So, a possible variation of this embodiment may be to combine the first embodiment (e.g. FIG. 11) with this embodiment. In other words, when there are only two matched data sectors use the first embodiment, and when there are more than two matched data sectors use the second embodiment.

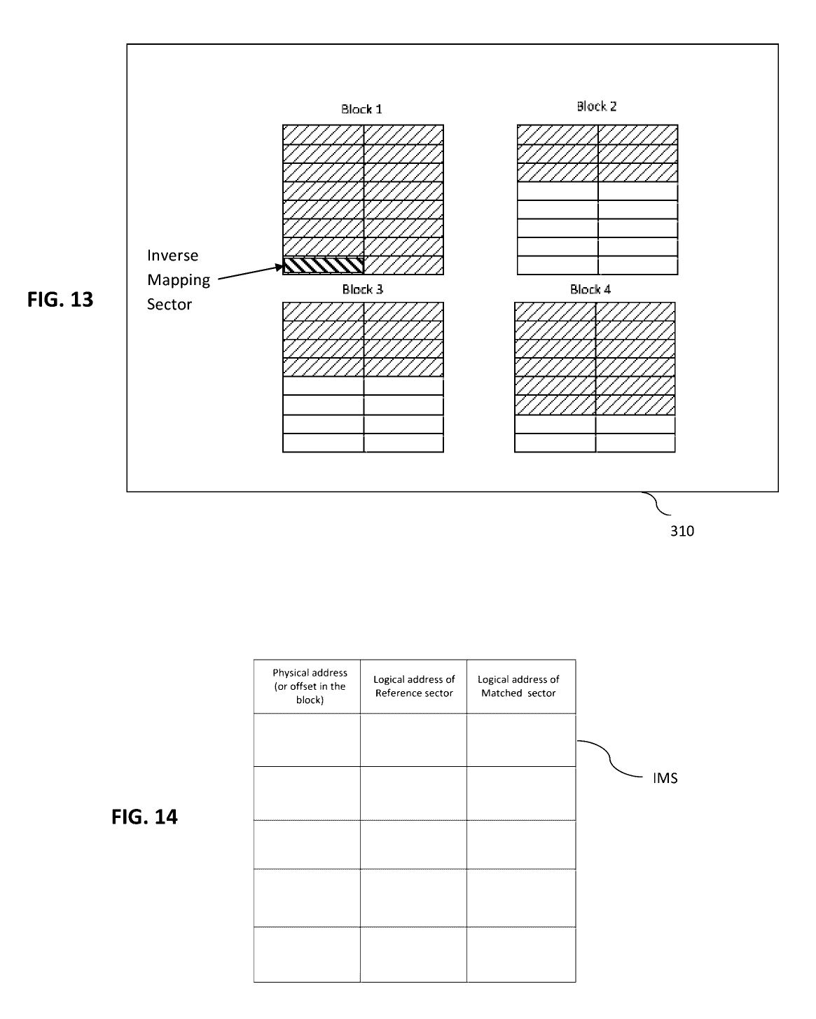

In a third embodiment (referring additionally to FIGS. 13 and 14), the physical-to-logical information may comprise an inverse-mapping-sector defined by a physical address of the physical sector storing the reference data sector, and logical addresses of the reference data sector and the corresponding matched data sector. The designated physical-to-logical information area may be a last physical sector in the block (e.g. Block 1) to store the inverse-mapping-sector as shown in FIG. 13.

The physical address in the inverse-mapping-sector IMS may be defined by an offset relative to a first physical sector in the block.

Many deduplication approaches perform deduplication on the several last sectors written to the memory device 100. One possible approach is inserting a hash signature (for example CRC) of sectors from the host into a hash table. Once the hash table becomes full with signatures, old signatures are evacuated from the hash table, depending on the specific process, in order to accommodate space for signatures of new sectors. Therefore, the hash table represents the last (i.e. the newest) sectors written to the memory cell array 310, e.g. NAND flash. The newest sectors are typically written to specific blocks.

As an example, suppose that the hash table represents signatures of M sectors, and that the M sectors were written into L different blocks. For each of the L blocks, the last page is left unwritten. The memory controller 200 will collect from the deduplication operation all the data sectors that are matched with reference sectors from the block. For a certain block, if there are data sectors matched with reference sectors from the block, then the last page (or sector) of the block will be used to store the physical-to-logical mapping of the matched sectors which may be referred to as an “inverse-mapping-sector.”

FIG. 14 shows an example structure (e.g. a table) of the inverse-mapping-sector IMS. The field of Physical address or offset means the address of the reference data sector in the block. As an option, to save space, instead of writing the full physical address, only the offset relative to the first sector of the block may be written. The other two fields of each entry are the logical addresses of the reference sector and of the matched sector

Upon garbage collection of a certain block, the “inverse-mapping-sector” is read from the last sector of the block. In order to find out whether a certain sector is valid, its logical address is read from the inverse-mapping-sector. The logical address is used as a key to the logical-to-physical FTL table. The physical address is read from the logical-to-physical FTL table. If the physical address in the FTL table is identical to the physical address in the Inverse-mapping-sector, then the sector is valid, otherwise it is not. If the sector is valid, then it will be copied to another location of the block after garbage collection.

The logical addresses in the inverse-mapping-sector will be used in order to access and update the logical-to-physical FTL table. This embodiment may not need additional mapping to the FTL. In the FTL both reference and new logical addresses are mapped to the same physical sector address.

The inverse-mapping-sector in the memory cell array 310 facilitates garbage collection. Upon garbage collection, the inverse-mapping-sector is read from the memory cell array 310, and the logical addresses of matched and reference data sectors are read from the inverse-mapping-sector. A large number of sectors can be referenced to the same sector, since there is a lot of space in the inverse-mapping-sector IMS.

This method may not need a buffer, since the inverse-mapping-sector can be written to the memory cell array 310 after the reference data sectors were already written. This embodiment may increase the complexity of the firmware, since the inverse-mapping-sector must be written to the same block (e.g. Block 1) of the reference data sector.

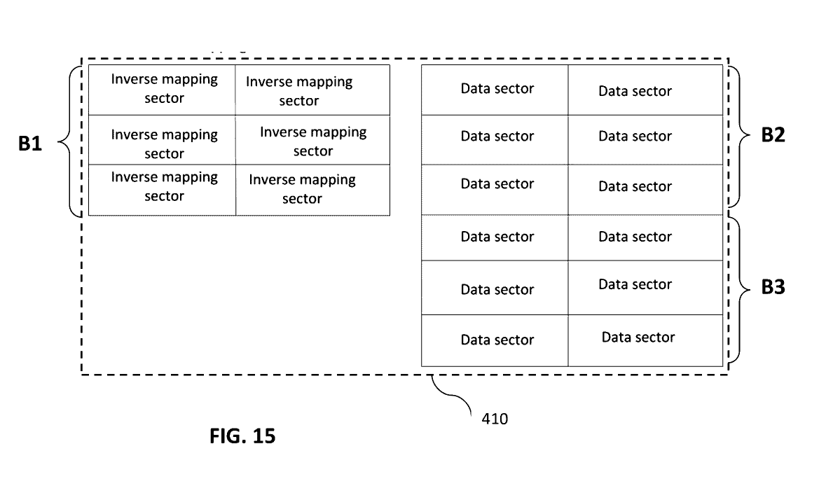

In a fourth embodiment (with additional reference to FIG. 15), the designated physical-to-logical information area may be a dedicated block B1 of the memory cell array 410 (e.g. flash memory) of memory device 100. The dedicated block B1 is configured to store inverse-mapping-sectors for blocks B2, B3 etc. of the memory cell array 410. Also, the memory controller 200 may include the use of RAM 230 to store a mapping of the inverse-mapping-sectors of the dedicated block B1.

This embodiment is similar to the third embodiment, except that the inverse-mapping-sector IMS is written to a dedicated block B1, instead of in the last sector of the same block as the reference sector. The firmware may assign a dedicated inverse-mapping-sector for each block B2, B3 that has reference data sector.

The physical address of the inverse-mapping-sector may be stored in an additional data structure or table in the RAM 230 (e.g. DRAM or SRAM) that may be referred to as the mapping-of-inverse-mapping-sectors. Upon garbage collection of a certain block, the physical address of the block will be the key to the table mapping-of-inverse-mapping-sectors

If there is deduplication in the block (i.e. the block stores data sectors that are reference sectors), then the mapping-of-inverse-mapping-sectors will include the address of the inverse-mapping-sector. The inverse-mapping-sector will be read from the memory cell array 410, and the FTL table will be updated. This embodiment may need a very small additional mapping to the FTL (for the mapping-of-inverse-mapping-sectors). In the FTL both reference and new logical addresses are mapped to the same physical address.

The inverse-mapping-sector in the memory cell array 410 facilitates garbage collection. Upon garbage collection, the inverse-mapping-sector is read from the memory cell array 410, and the logical addresses of matched and reference sectors are read from the inverse-mapping-sector.

In this embodiment, a large number of data sectors can be referenced to the same sector, since there is a lot of space in the inverse-mapping-sector. This method may not need a buffer for matching and deduplication since the inverse-mapping-sector can be written to the memory cell array 410 after the reference data sectors are already written. This approach may increase the complexity of the firmware, since the inverse-mapping-sector is written to the same block as the reference sector.

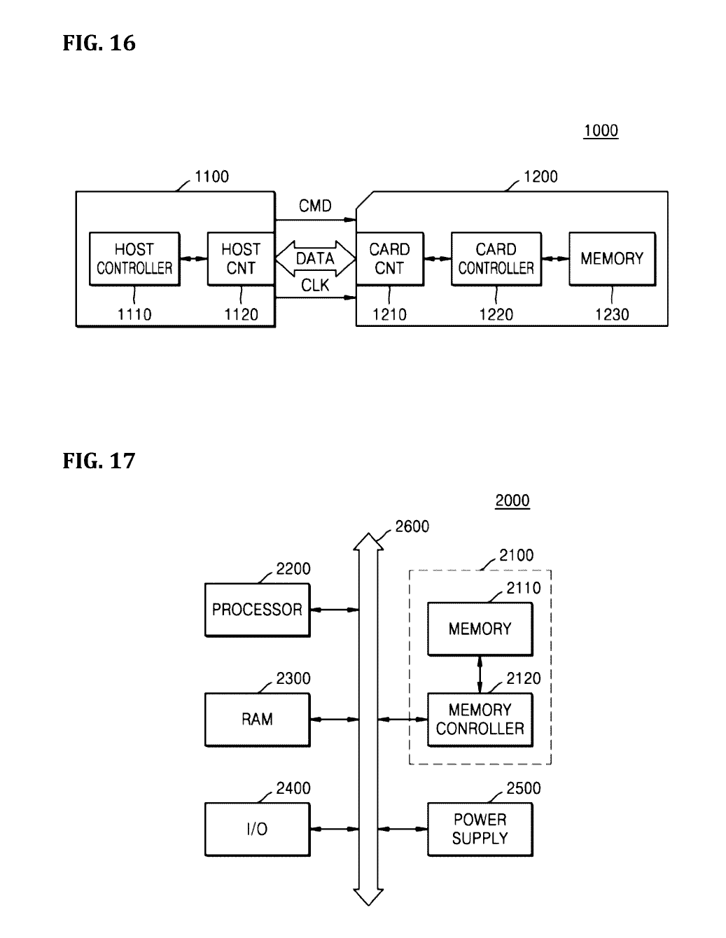

FIG. 16 is a block diagram illustrating a memory card system 1000 to which a memory system is applied, according to an exemplary embodiment. Referring to FIG. 16, the memory card system 1000 may include a host 1100 and a memory card 1200. The host 1100 may include a host controller 1110 and a host connector 1120. The memory card 1200 may include a card connector 1210, a card controller 1220, and a memory device 1230. In this case, the memory card 1200 may be formed by using the exemplary embodiments of FIGS. 1-8 and 11-15.

The host 1100 may write data to the memory card 1200 or may read data that is stored in the memory card 1200. The host controller 1110 may transmit a command CMD, a clock signal CLK that is generated by a clock generator (not shown) in the host 1100, and data DATA to the memory card 1200 through the host connector 1120.

The card controller 1220 may store the data DATA in the memory device 1230 in synchronization with a clock signal that is generated by a clock generator (not shown) in the card controller 1220, in response to the command CMD received through the card connector 1210. The memory device 1230 may store the data DATA that is transmitted from the host 1100.

The memory card 1200 may be a compact flash card (CFC), a microdrive, a smart media card (SMC), a multimedia card (MMC), a security digital card (SDC), a memory stick, or a USB flash memory driver.

FIG. 17 is a block diagram illustrating a computing system 2000 including a memory system 2100, according to an exemplary embodiment. Referring to FIG. 17, the computing system 2000 may include the memory system 2100, a processor 2200, a RAM 2300, an input/output device 2400, and a power supply 2500. Although not shown in FIG. 17, the computing system 2000 may further include ports that may communicate with a video card, a sound card, a memory card, a USB device, or other electronic devices. The computing system 2000 may be a personal computer, or a portable electronic device such as a laptop computer, a mobile phone, a personal digital assistant (PDA), or a camera.

The processor 2200 may perform specific calculations and tasks. According to exemplary embodiments, the processor 2200 may be a microprocessor or a CPU. The processor 220 may communicate with the RAM 2300, the input/output device 2400, and the memory system 2100 via a bus 2600 such as an address bus, a control bus, or a data bus. In this case, the memory system 2100 may be formed by using the exemplary embodiments of FIGS. 1-8 and 11-16.

According to exemplary embodiments, the processor 2200 may be connected to an expansion bus such as a PCI bus.

The RAM 2300 may store data that is necessary to operate the computing system 2000. For example, the RAM 2300 may be a DRAM, a mobile DRAM, an SRAM, a PRAM, a ferroelectric RAM (FRAM), an RRAM, and/or an MRAM.

The input/output device 2400 may include an input unit such as a keyboard, a keypad, and/or a mouse and an output unit such as a printer and/or a display. The power device 2500 may supply an operating voltage that is necessary to operate the computing system 2000.

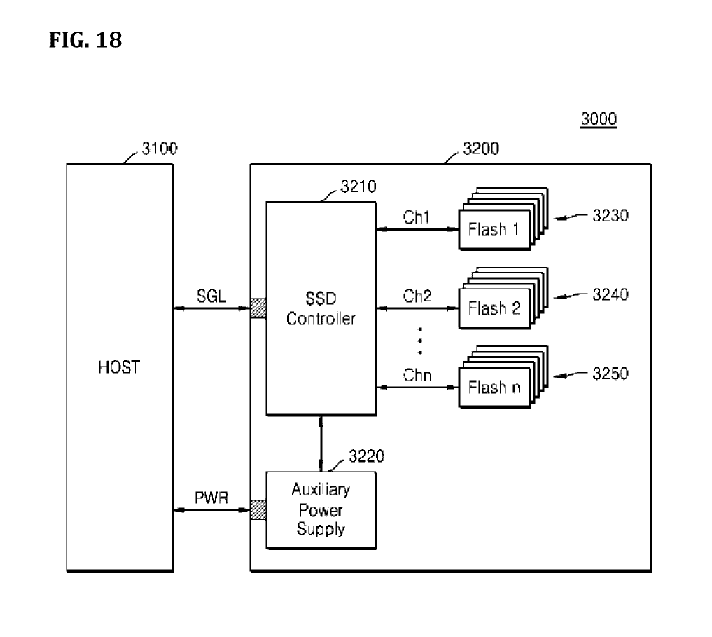

FIG. 18 is a block diagram illustrating a solid-state drive (SSD) system 3000 to which a memory system is applied, according to an exemplary embodiment. Referring to FIG. 18, the SSD system 3000 may include a host 3100 and an SSD 3200. The SSD 3200 transmits and receives a signal to and from the host 3100 through a signal connector, and receives power through a power connector. The SSD 3200 may include an SSD controller 3210, an auxiliary power device 3220, and a plurality of memory devices 3230, 3240, and 3250. In this case, the SSD 3200 may be formed by using the exemplary embodiments of FIGS. 1-8 and 11-17.

The foregoing is illustrative of embodiments and is not to be construed as limiting thereof. Although a few embodiments have been described, those skilled in the art will readily appreciate that many modifications are possible in the embodiments without departing from the scope of the inventive concept as defined in the claims.

1. A method of operating a data storage device including a control unit and a flash memory that includes blocks of physical pages that include physical sectors to store data therein, the method comprising:
receiving write data sectors to be stored in the flash memory;
determining at least one matched data sector by matching a write data sector with a reference data sector based upon a deduplication operation;
storing the reference data sector corresponding to the matched data sector in a physical sector of a physical page of a block in the flash memory;
mapping logical-to-physical addresses of the reference data sector and the corresponding matched data sector in a flash translation layer (FTL) of the control unit; and
writing physical-to-logical information regarding the corresponding matched data sector in a designated physical-to-logical information area of the flash memory.

2. The method of claim 1, wherein the physical-to-logical information comprises logical addresses of the reference data sector and the corresponding matched data sector; and wherein the designated physical-to-logical information area comprises a metadata area in the physical sector storing the reference data sector.

3. The method of claim 2, wherein the deduplication operation includes the use of a buffer for determining the matched data sector before the reference data sector is stored in the physical sector of the physical page of the block in the flash memory.

4. The method of claim 1, wherein the physical-to-logical information comprises a logical address of the corresponding matched data sector; wherein a logical address of the reference data sector is written to a metadata area in the physical sector storing the reference data sector; and
wherein the designated physical-to-logical information area comprises an adjacent physical sector, in the same physical page of the physical sector storing the reference data sector.

5. The method of claim 4, wherein the at least one matched data sector comprises a plurality of matched data sectors; and wherein writing physical-to-logical information comprises writing logical addresses of the plurality of matched data sectors in the adjacent physical sector which defines an address sector of the physical page.

6. The method of claim 5, wherein the deduplication operation includes the use of a buffer for determining the plurality of matched data sectors before the reference data sector is stored in the physical sector of the physical page of the block in the flash memory.

7. The method of claim 1, wherein the physical-to-logical information comprises an inverse-mapping-sector defined by a physical address of the physical sector storing the reference data sector, and logical addresses of the reference data sector and the corresponding matched data sector; and wherein the designated physical-to-logical information area comprises a last physical sector in the block and storing the inverse-mapping-sector.

8. The method of claim 7, wherein the physical address in the inverse-mapping-sector is defined by an offset relative to a first physical sector in the block.

9. The method of claim 1, wherein the physical-to-logical information comprises an inverse-mapping-sector defined by a physical address of the physical sector storing the reference data sector, and logical addresses of the reference data sector and the corresponding matched data sector; and wherein the designated physical-to-logical information area comprises a dedicated block of the flash memory configured to store inverse-mapping-sectors for blocks of the flash memory.

10. The method of claim 9, further comprising storing a mapping of the inverse-mapping-sectors of the dedicated block in a RAM of the control unit.

11. The method of claim 10, further comprising performing garbage collection on the flash memory including reading the mapping of the inverse-mapping-sectors from RAM, reading the inverse mapping sectors from the flash memory, and reading the logical-to-physical addresses from the FTL.

12. The method of claim 1, further comprising performing garbage collection on the flash memory including reading the physical-to-logical information from the designated physical-to-logical information area of the flash memory, and reading the logical-to-physical addresses from the FTL.

13. The method of claim 1, wherein the physical pages include an array of memory cells, including at least one of single-level cells (SLC), multi-level cells (MLC) and triple-level cells (TLC), coupled between word lines and bit lines.

14. A data storage system comprising:
a flash memory including blocks of physical pages that include physical sectors configured to store data therein; and
a memory control unit including a flash translation layer (FTL), and configured to
receive write data sectors to be stored in the flash memory,
determine at least one matched data sector by matching a write data sector with a reference data sector based upon a deduplication operation,
store the reference data sector corresponding to the matched data sector in a physical sector of a physical page of a block in the flash memory,
map logical-to-physical addresses of the reference data sector and the corresponding matched data sector in the FTL; and
write physical-to-logical information regarding the corresponding matched data sector in a designated physical-to-logical information area of the flash memory.

15. The data storage system of claim 14, wherein the physical-to-logical information comprises logical addresses of the reference data sector and the corresponding matched data sector; and wherein the designated physical-to-logical information area comprises a metadata area in the physical sector storing the reference data sector.

16. The data storage system of claim 15, wherein the memory control unit includes a buffer; and wherein the deduplication operation includes the use of the buffer for determining the matched data sector before the reference data sector is stored in the physical sector of the physical page of the block in the flash memory.

17. The data storage system of claim 14, wherein the physical-to-logical information comprises a logical address of the corresponding matched data sector; wherein the memory control unit is configured to write a logical address of the reference data sector to a metadata area in the physical sector storing the reference data sector; and wherein the designated physical-to-logical information area comprises an adjacent physical sector, in the same physical page of the physical sector storing the reference data sector.

18. The data storage system of claim 17, wherein the at least one matched data sector comprises a plurality of matched data sectors; and wherein the memory control unit is configured to write physical-to-logical information as logical addresses of the plurality of matched data sectors in the adjacent physical sector which defines an address sector of the physical page.

19. The data storage system of claim 18, wherein the memory control unit includes a buffer; and wherein the deduplication operation includes the use of the buffer for determining the plurality of matched data sectors before the reference data sector is stored in the physical sector of the physical page of the block in the flash memory.

20. The data storage system of claim 14, wherein the physical-to-logical information comprises an inverse-mapping-sector defined by a physical address of the physical sector storing the reference data sector, and logical addresses of the reference data sector and the corresponding matched data sector; and wherein the designated physical-to-logical information area comprises a last physical sector in the block to store the inverse-mapping-sector.

21-26. (canceled)
